(19) United States
(12) Patent Application Publication
(10) Pub. No.: US 2007/0088448 A1
(43) Pub. Date: Apr. 19, 2007

(54) PREDICTIVE CORRELATION MODEL SYSTEM

(75) Inventors: Dinkar Mylaraswamy, Fridley, MN (US); Wendy K. Foslien, St. Paul, MN (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL INC., Morristown, NJ (US)

(21) Appl. No.: 11/163,445

(22) Filed: Oct. 19, 2005

(51) Int. Cl. G05B 13/02

(52) U.S. Cl. 700/44; 700/29; 700/45

(57) ABSTRACT

A system having a combination including a predictive controller and a correlation model analysis which may include a principal component analysis (PCA) calculator. The system may encompass a discrete sampler of trajectories of variables from the predictive controller for a correlation model analysis calculation. There may be a compensator for providing initialization and estimation values of other system variables for the correlation model analysis. An uncertainty calculator connected to the predictive controller may output an anomaly impact prediction zone based on upper and lower bounds from the predictive controller.

### BACKGROUND

The invention pertains to prognostics, and particularly to an aspect of principal component analyses. More particularly, the invention pertains to the use of prognostics as they relate to correlation model systems.

### SUMMARY

The invention may be a system that uses a predictive controller with a correlation model system or, for instance, a principal component analysis apparatus or module.

### BRIEF DESCRIPTION OF THE DRAWING

FIG. 1 is a diagram of a predictive correlation model system; and

FIG. 2 shows an anomaly prediction of a predictive controller of the system.

### DESCRIPTION

Prognostics may include a prediction of the impact of an abnormality or anomaly of an apparatus or system in the future. Often, a health monitoring system may provide a good assessment of anomalies present in an apparatus at any given time. However, tremendous benefits may be realized if one could predict how these anomalies will evolve and impact the apparatus in some future time. The present system may fill this gap.

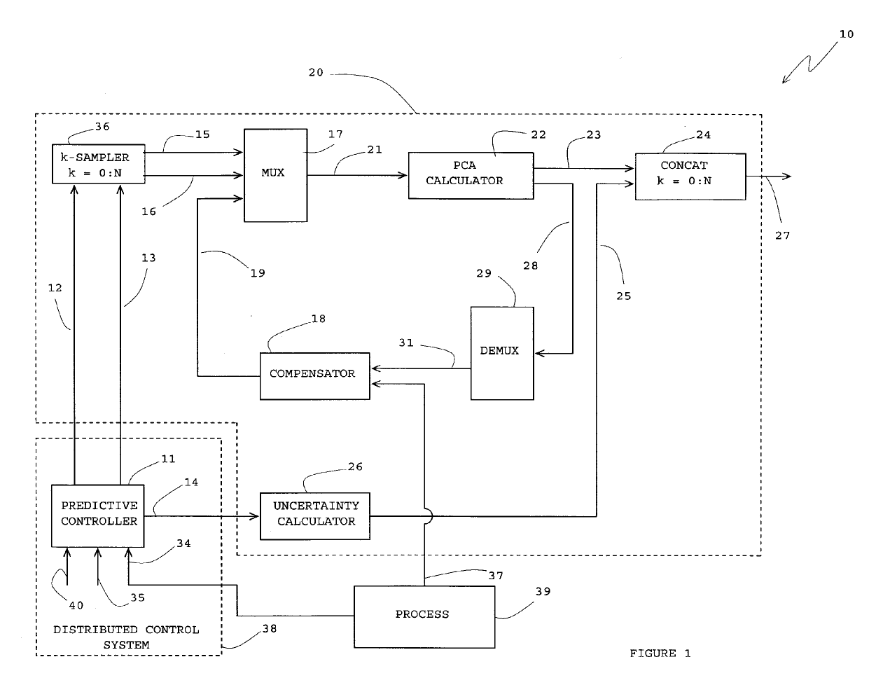

A system 10 of FIG. 1 may predict the impact of anomalies in an apparatus or system using a combination of a predictive component and a nominal model of the apparatus or system. The nominal model may be regarded as a correlation model, for instance, such as one captured by a principal component analysis. The predictive component may be a horizon based controller. In an illustrative example, the predictive component may be a model predictive controller. In another illustrative example, a principal components model may capture nominal behavior of an apparatus or system. It may provide a statistical limit for acceptable system behavior; excursions beyond the limit may indicate anomalies resulting from an incipient fault. A predictive controller may be designed to move the system from point A to point B using a series of manipulated variables (MV). By combining the anomaly detection capability of a principal components model with future moves that a predictive controller may be making of the system, one may predict whether the system behavior will be acceptable or not in some distant future. An impact of the anomaly may be predicted, thus revealing a prognostic capability of the present system 10.

An overall working of an example system 10 is illustrated in FIG. 1. This system may have five main functional elements. The elements may include a predictive controller 11, a principal component analysis (PCA) calculator 22, a discrete sampler 36, a compensator 18, and an uncertainty calculator 26 as desired.

Inputs to the predictive controller 11 may include a present measurements signal and a predictive controller horizon signal. Outputs of controller 11 may include trajectories of manipulated variable moves and controlled variables. At each point in time, the predictive controller 11 may provide a trajectory of manipulated variable moves that the controller is planning on making in the future. A trajectory may imply a sequence of moves (in conjunction with a time element). In some contexts, “moves” and “trajectory” may be interchangeable. The terms may indicate a future layout. It may also provide a trajectory for how the controlled variables (CV) will evolve over the prediction horizon.

The overall PCA block 20 may calculate a lack-of-fit estimate using pre-determined correlations that describe nominal apparatus or system behavior. At each point, this block may execute a principal component analysis calculation within module 22. In an illustrative example, the block may receive a sample vector, scale the variables and transform the variables into a latent space. The scaling may change from one sample to another. In this case, the PCA block may include a scheme for updating the scales. The transformation of variables into latent space may be done by projecting the sample using a linear orthogonal basis vectors. In an illustrative example, these orthogonal basis vectors may be calculated previously using an established singular value decomposition algorithm. The PCA block may also project the latent variables into the original measurement space and provide estimates for all variables. These estimates may assume that the correlation captured by the PCA model is still valid. The PCA block may also calculate statistics such as a Q statistic which provides a measure for an anomaly caused by breakdown of correlations, which could be a due to an incipient fault and future controller moves.

The discrete sampler 36 may provide samples of the trajectories provided by the controller 11 as synchronized data vectors. These data vectors may be input to the PCA calculation block 22.

The compensator 18 may provide future values of other system variables. This block may compensate for the lack of variables needed by the PCA model that cannot be provided by the controller. This block may be a simple single step predictor with zero order hold. Here, the values may be repeated if new values cannot be calculated and provided to the predictor.

The uncertainty calculator 26 may use the upper and lower bounds from the predictive controller 11 to calculate an anomaly prediction cone for output 25. If the predictive controller can indicate uncertainties associated with various trajectories, then this block may use this information to calculate an uncertainty arising from the PCA block. This block also may execute a simple worst case analysis algorithm and provide an upper bound on how the anomaly may evolve. If there are no bounds relative to the prediction, then there should be no need for the uncertainty calculator 26.

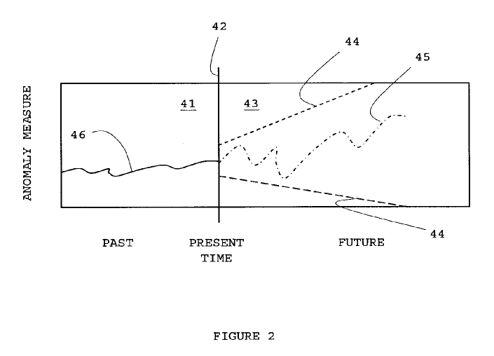

FIG. 2 is a diagram showing an anomaly measure versus time, i.e., the past 41, the present time 42 and the future 43. Operation may be at the present time 42, where k=0. The past 41 may be where k=−1, −2, and so forth. An anomaly measure 46 is of the past. The future may be where k=1, 2, . . . N. An anomaly trajectory 45, which may be at the output 23, is shown in the future 43. Also, in the future 43 is the uncertainty cone 44 which may be provided at output 25.

Given the current state of the apparatus or system, with any incipient fault, the present system may provide a means to analyze in how the apparatus or system will behave when the control moves are implemented. Since the predictive controller may be oblivious to any incipient faults, future control moves may escalate the situation and cause severe secondary effects--including safety and operational hazards. Thus, the present system may help the decision maker in understanding the impact of controller moves under the presence of incipient faults. If at any given point in time, there are no incipient faults, then the system may predict that the control move will not cause any anomalies.

The present system may relate to the area of predictive principal component analyses or the like. The system may be a combination of principal component analysis for anomaly detection and a predictive controller for control moves. The use of future controller moves to predict how the anomaly will evolve is a main thrust of the system.

As indicated above, FIG. 1 is a diagram showing an illustrative example of a predictive principal component analysis system 10, which includes the predictive controller 11. System 10 may contain a predictive controller 11 and a principal component analysis mechanism 20 or an equivalent mechanism. Predictive controller 11 may be a module that is part of a distributed control system (DCS) 38. The DCS may be a computer network for a process, plant, refinery, or the like, and may have other modules (e.g., a planner). Predictive controller 11 may provide an output 12 of a trajectory of manipulated variable (MV) moves (u(1), u(2), . . . (n)), which controller 11 is planning on in the future. Controller 11 may also provide an output 13 trajectory of controlled variables (CV) and how they will evolve (y(1), y(2), . . . y(n)) over the prediction horizon. Also, a prediction uncertainty indication 14 may be output by controller 11. Outputs 12 and 13 may go to a discrete sampler 36 which samples the trajectories of MV and CV provided by the controller into synchronized data vectors u(k) and y(k), respectively, where k=0:N, N is the number of samples of the predictive controller horizon. The vectors u(k) and y(k) may be output as signals 15 and 16, respectively, to a multiplexer 17. Also, a compensator 18 may provide a compensating signal 19, w(k), to multiplexer 17. This signal 19 may compensate for the lack of variables needed by a PCA model which cannot be provided by the controller 11. The compensator 18 may be a simple single step predictor with a zero order hold. A w(0) signal 37 may go to compensator 18.

Inputs 15, 16 and 19 may be multiplexed as outputs 21 from multiplexer 17 to a PCA calculator 22. The inputs may be stacked in a long data vector. The PCA calculator 22 may scale the sample vectors u(k), y(k) and w(k) of signals 15, 16 and 19, and their variables, and transform the variables into a latent space. The scaling may change from one sample to another. The scheme for updating the scales may be done according to pre-established logic. The logic may be done using an exponentially weighted moving average scheme. The transformation may be done according to pre-calculated load vectors. The calculator 22 may project the latent variables into the original measurement space and provide estimates for all variables. For these estimates, it may be assumed that the correlation captured by the PCA model is yet valid. A key statistic, such as a Q statistic (Q(k)), may be calculated by the PCA calculator 22 and provided as an output signal 23 to a concat mechanism 24 for k=0:N. (Concat may be concat(dim, a, b) which may concatenate, for example, arrays a and b (or any number k of arrays) along dimension “dim” into a single matrix.)

The Q statistic signal 23 may provide a measure of an anomaly caused by a combination incipient fault and future controller moves. Another input to concat mechanism 24 may be a Q prediction cone signal 25 from an uncertainty calculator 26. Calculator 26 may base the output signal 25 on the basis of the prediction uncertainty signal from the predictive controller 11. The uncertainty calculator 26 might provide an uncertainty signal associated with various trajectories, and, if so, the calculator 26 may use information 14 from controller 11 to calculate an uncertainty signal 25 arising from the PCA calculator 22. The uncertainty calculator 26 may execute a simple worst case analysis algorithm and provide an upper bound on how an anomaly may evolve. From input signals 23 and 25, the concat mechanism or block 24 may provide an output signal 27 conveying a future Q trajectory.

The PCA calculator 22 may also output a signal 28 containing estimates. The estimates may go to a demultiplexer 29 that may separate signals (ŵ(k), the estimate of w(k)) for the compensator 18. Signal 31 denotes this in FIG. 1.

Also, coming into the predictive controller 11 may be present measurements 34 containing u(0), y(0), w(0) is not needed by the predictive controller and this is a main reason for having a compensator. The predictive controller may need many other inputs, but will include u(0) and y(0). Also, an “N=predictive controller horizon” signal 35 may be input to controller 11. Also, coming into the predictive controller 11 may be setpoints and/or target values 40. A signal 37 may include a measurement w(0) that goes to compensator 18 from a process 39 (e.g., plant). The inputs (u(0), y(0) and w(0)) come from the process 39. Signal 37 may be an initialization signal to the compensator.

In the present specification, some of the matter may be of a hypothetical or prophetic nature although stated in another manner or tense.

Although the invention has been described with respect to at least one illustrative example, many variations and modifications will become apparent to those skilled in the art upon reading the present specification. It is therefore the intention that the appended claims be interpreted as broadly as possible in view of the prior art to include all such variations and modifications.

What is claimed is:

1. A predictive system comprising:
a correlation model module; and
a predictive controller connected to the correlation model module; and
wherein the correlation model module comprises:
a sampler connected to the predictive controller;
a principal component analysis calculator connected to the sampler; and
an output interface module connected to the principal component analysis calculator.

2. The system of claim 1, wherein the correlation model module further comprises:
a multiplexer having an input connected to the sampler and an output connected to the principal component analysis calculator;
a compensator having an output connected to the multiplexer; and
a demultiplexer having an input connected to the principal component analysis calculator and an output connected to the compensator.

3. The system of claim 2, wherein:
the compensator receives an initialization signal from a process;
a first input to the predictive controller is a present measurements signal;
a second input to the predictive controller is a predictive controller horizon signal;
a third input to the controller includes setpoints and/or target values;
a first output from the predictive controller to the sampler is a trajectory of manipulated variable moves;
a second output from the predictive controller to the sampler is a trajectory of controlled variables; and
the sampler samples the trajectory of manipulated variable moves and the trajectory of controlled variables into synchronization data vectors as an output to the multiplexer.

4. The system of claim 3, wherein:
an initialization signal and/or a compensating signal goes from the compensator to the multiplexer;
an output of the principal component analysis calculator provides a statistic of a measure of an anomaly to the interface output module and provides estimates to the input of the demultiplexer; and
the interface output module outputs a future trajectory.

5. The system of claim 4, further comprising:
an uncertainty calculator having an input connected to the predictive controller; and
wherein the uncertainty calculator provides an anomaly prediction cone to the output interface module.

6. The system of claim 5, wherein the predictive controller is a horizon based controller.

7. A predictive correlation model system comprising:
a predictive controller; and
a correlation model module connected to the predictive controller.

8. The analyzer of claim 7, wherein the correlation model module comprises:
a sampler connected to the predictive controller;
a multiplexer connected to the sampler; and
a correlation model calculator connected to the multiplexer.

9. The analyzer of claim 8, wherein the correlation module further comprises an output interface mechanism connected to the correlation model calculator.

10. The analyzer of claim 9, wherein the correlation model module further comprises:
a demultiplexer connected to the correlation model calculator; and
a compensator connected to the demultiplexer and the multiplexer.

11. The analyzer of claim 10, further comprising an uncertainty calculator connected to the predictive controller and to the output interface mechanism.

12. A predictor system comprising:
a predictive controller; and
a principal component analyzer connected to the predictive controller.

13. The system of claim 12, wherein the principal component analyzer comprises:
a sampler connected to the predictive controller;
a principal component analysis calculator connected to the sampler; and
an output interface mechanism connected to the principal component analysis calculator.

14. The system of claim 13, wherein:
the predictive controller outputs trajectory information to the sampler; and
the sampler places the trajectory information into data vectors to be sent to the principal component analysis calculator.

15. The system of claim 14, wherein the principal component analysis calculator transforms the data vectors into information about an anomaly.

16. The system of claim 15, wherein the information about an anomaly includes information about a prediction of an impact of the anomaly.

17. The system of claim 16, further comprising a compensator connected to the principal component analysis calculator.

18. The system of claim 17, wherein the compensator may provide information to the principal component analysis calculator not provided by the predictive controller.

19. The system of claim 18, further comprising uncertainty calculator connected to the predictive controller and to the output interface mechanism.

20. The system of claim 19, wherein the uncertainty calculator provides a bound on the prediction of the impact of the anomaly to the output interface mechanism.

21. The system of claim 20, wherein:
a first input signal to the predictive controller includes present measurements of a process;
a second signal to the predictive controller includes a predictive horizon;
a third signal to the predictive controller includes setpoints and/or target values; and
an initialization signal to the compensator includes additional measurements of a process.
